(19) United States
(12) Patent Application Publication
(10) Pub. No.: US 2026/0296218 A1
(43) Pub. Date: Oct. 1, 2026

(54) Cell Monitoring System for an Energy Storage Device for an Electrically Driveable Motor Vehicle, Energy Storage Device and Motor Vehicle

(71) Applicant: Bayerische Motoren Werke Aktiengesellschaft, Muenchen (DE)

(72) Inventors: Robert ALIG, Germering (DE); Thomas GLASS, Mainburg (DE)

(21) Appl. No.: 19/489,774

(22) PCT Filed: May 28, 2024
(86) PCT No.: PCT/DE2024/100488

§ 371 Date: Dec. 3, 2025

(30) Foreign Application Priority Data
Jun. 21, 2023 (DE) 10 2023 116 264.0

(51) Int. Cl. B60L 50/60; B60R 16/033

(52) U.S. Cl. CPC B60L 50/60; B60R 16/033; B60L 2210/42; B60L 2240/525

(57) ABSTRACT

A cell monitoring system for an energy storage device for an electrically driveable motor vehicle having a vehicle-side electrical interface is configured to be connected to a plurality of voltage taps, the voltage taps are each designed to electrically contact a cell of the energy storage device. The cell monitoring system has a control device for controlling the voltage taps, and the cell monitoring system is designed to electrically connect the cells to the vehicle-side electrical interface via the plurality of voltage taps.

### BACKGROUND AND SUMMARY

The present disclosure relates to a cell monitoring system for an energy storage device for an electrically driveable motor vehicle having a vehicle-side electrical interface, wherein the cell monitoring system can be connected to a plurality of voltage taps, and the voltage taps are each designed to electrically contact a cell of the energy storage device. The disclosure further relates to an energy storage device for an electrically driveable motor vehicle, comprising a plurality of cells and a cell monitoring system, and to an electrically driveable motor vehicle, comprising a cell monitoring system and/or an energy storage device.

Electrically driveable motor vehicles are known from the prior art. In this case, vehicles with a battery-electric drive are known, for example, as a plug-in hybrid electric vehicle (PHEV) or as a battery electric vehicle (BEV). Such motor vehicles typically have an energy storage device known as a traction battery or high-voltage battery for storing and providing electrical energy.

It is known to configure the motor vehicle or the energy storage device for so-called bidirectional charging in order to be able to selectively draw or supply electrical energy from/to the energy storage device. For example, a user can thus supply 230 V devices, for example, and/or use the motor vehicle or the energy storage device for bidirectional operation as a stationary storage device in his own house. Charging and bidirectional charging are currently effected primarily via the charging socket of the motor vehicle. It is therefore known that such motor vehicles have an interface for transmitting electrical energy between the energy storage device and a power grid external to the vehicle.

DE 10 2008 031 125 A1 discloses a method for controlling a bidirectionally operable voltage converter device and a multi-voltage on-board electrical system.

Furthermore, it is known that motor vehicles have a solar cell which is designed to feed electrical energy into the energy storage device. DE 10 2009 057 919 A1 discloses an electrical system for a motor vehicle having at least two voltage levels, having at least one consumer for each of the two voltage levels and having at least two energy stores, wherein the electrical system comprises a first generator which generates a first electrical voltage, the amplitude of which substantially determines an electrical potential of a first voltage level, and in that the electrical system comprises a second generator which generates a second electrical voltage, the amplitude of which substantially determines the electrical potential difference between the first voltage level and a second voltage level, the electrical potential of which is higher than that of the first voltage level, wherein the second generator is designed as a solar generator of a solar roof.

However, in particular for bidirectional charging, a plurality of control units and bus systems of the vehicle must be woken up and operated. The control units and bus systems are secondary consumers and can impair the energy balance. The cause for this can be the mostly distributed functions of the multiple control units with respect to the actuation of various actuators such as contactors, converters, etc., and with respect to function monitoring, for example, for achieving electrical safety, functional safety, etc. The totality of the control units and of the bus system can in this case consume such electrical energy that the current draw becomes inefficient and/or uneconomical in the case of small consumers. This is particularly important in the case of frequent use in a stationary motor vehicle.

The same applies in the case of feeding in electrical energy via a solar cell which is likewise connected via an electrical interface of the motor vehicle to the energy storage device for feeding in electrical energy. In this case, particular low consumption of the secondary consumers should be ensured, since otherwise the energy storage device cannot be charged or can only be charged insignificantly or may even be discharged.

Against the background of this prior art, it is an object of the present disclosure to enrich the prior art and to improve at least the above-mentioned aspects of the prior art. In particular, an object of the disclosure is to reduce or largely avoid a load due to secondary consumers when removing electrical energy from the energy storage device and/or feeding electrical energy into the energy storage device in each case with low power.

This object is achieved by the features disclosed herein, which also includes developments of the disclosure.

According to this, this object is achieved by a cell monitoring system for an energy storage device for an electrically driveable motor vehicle having a vehicle-side electrical interface, wherein the cell monitoring system can be connected to a plurality of voltage taps, and the voltage taps are each designed to make electrical contact with a cell of the energy storage device; the cell monitoring system has a control device for controlling the voltage taps; and the cell monitoring system is designed to electrically connect the cells to the vehicle-side electrical interface via the plurality of voltage taps.

The energy storage device can have a plurality of cells. The cells may be logical and/or physical cells. The cell monitoring system can electrically connect the cells to the interface in a controlled manner via the voltage taps by the control device and thus control the removal of electrical energy from one or more of the cells or the charging of one or more of the cells with electrical energy.

It has been recognized that a prior art cell monitoring system typically measures data relating to the cells. For this purpose, cell monitoring systems of this type have voltage taps as measurement lines (sensor lines). Such monitoring voltage taps can be routed separately from the electrical contactings for a power interface, for example for supplying the electrical drive with electrical energy. The voltage taps can be connected to a cell contacting system in order to save costs and/or installation space and to control the feeding and/or the removal of electrical energy. It has been recognized that, in the case of low power, it is not necessary to wake up, operate and/or control various other control units different from the cell monitoring system and the bus system for controlling the feeding and/or the removal of electrical energy. Accordingly, the cell monitoring system is proposed, which can decrease virtually any voltages at the voltage taps, in particular for voltage monitoring, even when the voltage of the energy storage device falls.

The cell monitoring system forms a front end at which all voltage taps are combined. Thus, monitoring of the cells can continue to take place. In addition, the measurement front end provided by the cell monitoring system may be used for tapping the voltage for electrically connecting the cells to the electrical interface. The control device may be referred to as a smart cell supervisor circuit. The voltage taps can each be used for feeding and discharging selectively, i.e., controlled in an open-loop and/or closed-loop manner by the control device.

By selectively connecting the cells or the voltage taps to the interface, it is also possible to transmit electrical energy with low power and in particular with low voltage. Thus, the control of the transfer of the electrical energy can be simplified, since the transfer of the energy is less relevant to safety and results in less thermal losses. Complex monitoring by various control units can thus be dispensed with. By using the voltage taps, another path for providing and/or supplying electrical energy is used as a main current path and thus the remaining vehicle controllers can be bypassed. The energy storage device can be directly connected to the electrical interface as a source or sink. In this case, power can be taken separately from the main intermediate circuit, to which, for example, an electric drive is connected. The cell monitoring system with the voltage measurement taps requires further monitoring due to the power, voltage and/or dynamics, but critical thresholds are reached less quickly than in the main current path. It may thus be unnecessary to operate secondary consumers, such as control units and the bus system of the motor vehicle. Alternatively. however, a main control unit of the energy storage device and/or another control unit can also be woken if more functions are necessary and/or requested, for example for diagnosis. Thus, for example, bidirectional charging and/or feeding of electrical energy through a solar cell, in particular on the vehicle side, or a vehicle-side photovoltaic module arranged, for example, against and/or on an outer skin of the motor vehicle can be made more efficient, since impairment by secondary consumers is reduced. In addition, the voltage handles act as a natural fuse in the event of an overload, which can avoid measures for achieving the functional safety (FuSi for short) and can also avoid waking up the bus system and various control units. Optionally, one or more measurement lines may have to be amplified as a voltage tap, i.e., may have to be designed with a larger cross section, in order to be able to transport higher currents. Optionally, an additional overcurrent protection can be provided.

Optionally, the control device is designed to selectively connect one or more of the plurality of voltage taps to the electrical interface. In other words, the control device can selectively connect one or more voltage taps, that is to say a plurality of mutually different sets or subsets of voltage taps, and thus selectively connect one or more of the battery cells to the electrical interface. In particular, a different number of cells can also be connected to the electrical interface in order to achieve different voltages and/or currents.

Optionally, the control device is designed to be supplied with electrical energy by the cell and/or a plurality of cells. It can thus be avoided that, for example, the entire energy storage device and possibly a voltage converter for same must be operated in order to operate the control device. Rather, the control device can be supplied with electrical energy from one cell or a plurality of cells directly connected to the control device via one or a plurality of voltage taps.

Optionally, the control device comprises a plurality of control modules; wherein each of the control modules is designed to selectively connect the electrical interface to a predetermined set of cells. It has been recognized that the control and/or monitoring of a predetermined set of cells by a control module can provide an effective architecture for the cell monitoring system. Each of the control modules may control six to twenty-four cells, for example. In this case, the energy requirement of each of the control modules is such that the respective control module can be effectively supplied with electrical energy by the cells connected to the control module for operating the control module. The control modules may be integrated, e.g., on a printed circuit board, to effectively utilize the packaging space and/or may be separately arranged to accommodate the control modules differently. Furthermore, the control modules or switching elements can be arranged on one or more printed circuit boards or chips (silicon), and can therefore be produced cost-effectively.

Optionally, the cell monitoring system comprises a cooling device for passive cooling of the control device. This makes it possible to avoid an auxiliary consumer for cooling the control device. This is possible since the control device typically controls the transport of electrical energy with comparatively low power.

Optionally, the control device is designed to control the connection of the electrical interface to the one or more of the plurality of voltage taps as a function of the load. In this case, the control device can have an optimizer function which, for example, adjusts the voltage and thus the cell taps in order to feed in electrical energy of a photovoltaic module, until an optimum power output of the photovoltaic module is established. Different cells can be supplied or loaded with different voltages. In addition, quasi-active balancing of the cells can be ensured without energy having to be converted into heat in the process.

Optionally, the control device is designed to control the connection of the electrical interface to the one or more of the plurality of voltage taps in a time-dependent manner. By time-dependent control, uniform charging of individual cells and/or uniform removal of electrical energy from individual cells can be achieved, for example. In addition, this enables a comparatively fast temporal control and optionally a conversion of the replication of an alternating voltage, wherein an amplitude of the alternating voltage can be determined in a time-dependent manner via the number of connected voltage taps or cells.

Optionally, the control device is designed to control the connection of the electrical interface to the one or more of the plurality of voltage taps such that an alternating current is modulated. Thus, by the control, an alternating current can be provided and an inverter output can thus be simulated. This principle can be used analogously for feeding energy.

Optionally, the control device has an inverter for supplying and/or charging the interface with an alternating current; and a subset of the voltage taps is connected to the inverter. By connecting the subset to the inverter, not each of the voltage taps has to be led to the DC/AC converter, but for example only every n-th with a natural number nb. Thus, only the relevant voltage taps need to be designed to be correspondingly strong, i.e., with a larger cross section, in order to reduce losses and to make it possible to conduct a sufficient amount of electrical energy in an efficient manner.

Optionally, the control device has an inverter with a resonant converter for supplying and/or loading the interface with an alternating current. The resonant converter can have a switchable capacitor and a switchable inductor in order to achieve a further reduction in conversion losses. The resonant converter or the switchable inductor and/or the switchable capacitor can be operated particularly advantageously by the flexible voltage taps in the resonant range.

According to an aspect of the disclosure, there is provided an energy storage device for an electrically driveable motor vehicle, comprising a plurality of cells and the above-described cell monitoring system. Optionally, the cell monitoring system has one or more features described as advantageous or optional in order to achieve a technical effect associated therewith.

According to one aspect of the disclosure, an electrically driveable motor vehicle comprising the above-described cell monitoring system and/or the above-described energy storage device is provided. Optionally, the cell monitoring system has one or more of the features described as advantageous or optional in order to achieve a technical effect associated therewith.

Optionally, the motor vehicle comprises a photovoltaic module which is designed to be connected to the cells via the vehicle-side electrical interface and the cell monitoring system. Thus, the cells can be charged.

One embodiment is described below with reference to the figures.

### BRIEF DESCRIPTION OF THE DRAWINGS

FIG. 1 schematically shows an electrically driveable motor vehicle with an energy storage device, each according to the prior art;

FIG. 2 schematically shows an electrically driveable motor vehicle with an energy storage device according to one aspect of the disclosure;

FIG. 3 schematically shows a cell monitoring system and a plurality of cells according to an aspect of the disclosure; and

FIG. 4 schematically shows two possibilities for selectively connecting one or more voltage taps to an electrical interface of an energy storage device and a voltage profile of a cell monitoring system according to an aspect of the disclosure.

### DETAILED DESCRIPTION OF THE DRAWINGS

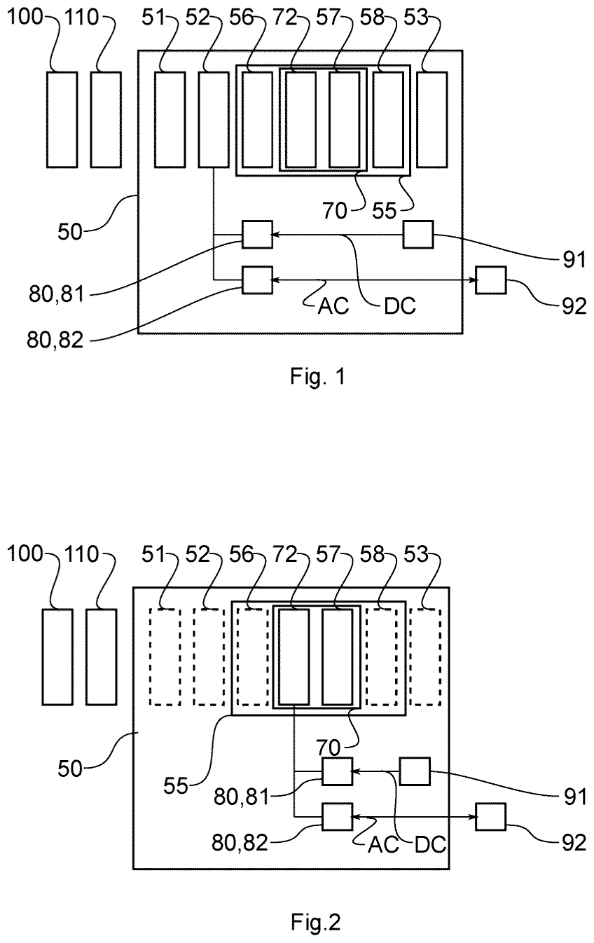

FIG. 1 schematically shows an electrically driveable motor vehicle 50 having an energy storage device 55, each according to the prior art. Furthermore, FIG. 1 shows a charging point 100 external to the vehicle.

The charging point 100 can comprise a charging column or a wallbox, and can be designed for charging and/or bidirectional charging of the motor vehicle 50 or of the energy storage device 55. For this purpose, the charging point 100 has a charging-point-side connecting element 110, for example a charging plug.

The motor vehicle 50 has a motor-vehicle-side connecting element 51, for example a charging socket. The charging-point-side connecting element 110 and the motor-vehicle-side connecting element 51 are designed to be operatively connected to one another so that the motor vehicle 50 or the energy storage device 55 of the motor vehicle 50 can be charged with electrical energy for charging and/or electrical energy can be removed from the energy storage device 55, for example in order to operate a device external to the vehicle and/or to feed the energy into a power grid external to the vehicle. The charging point 100 and the motor vehicle 50 are designed for rapid charging.

The motor vehicle 50 has a high-voltage line 52 or a line arrangement and/or a cable harness. The high-voltage line 52 is designed to electrically connect the vehicle-side connecting element 52 to the energy storage device 55 in order to transport electrical energy between the charging point 100 and the energy storage device 55.

The motor vehicle 50 has two electrical interfaces 80. Here, one of the interfaces 80 is a direct current interface 81 and the other of the interfaces 80 is an alternating current interface 82, and the interfaces 80 are electrically connected to the high voltage line 52 to electrically connect the interfaces 80 to the power storage device 55.

The motor vehicle 50 has a photovoltaic device 91. The photovoltaic device 91 is connected to the direct current interface 81 in order to be able to supply electrical energy generated by the photovoltaic device 91 in the form of a direct current DC to the energy storage device 55. The voltage of the direct current DC may include, for example, 60 V and is thus only a fraction of the voltage of the entire energy storage device 55.

The alternating current interface 82 is connectable to a power grid 92 external to the vehicle. The power grid 92 external to the vehicle may include a consumer operable by an alternating current AC. For this purpose, the alternating current interface 82 can be designed as a vehicle-side socket.

The energy storage device 55 is designed to store and provide electrical energy, in particular for driving the motor vehicle 50. The energy storage device 55 is a high-voltage battery and has a battery control unit 56, a cell monitoring system 70, a cell contacting system 72, a plurality of cells 57 and a temperature control device 58.

The battery control unit 56, also referred to as the main control unit, battery management unit, or BMU, is designed to control, i.e., to control in an open-loop manner, control in a closed-loop manner and/or monitor, the function of the entire energy storage device 55. For this purpose, the battery control unit 56 can comprise a data processing device and a cooling device on the battery control unit side.

The cell contacting system 70 is designed to electrically contact the cells 57 of the energy storage device 55 and thus to enable the transport of electrical energy. The cell monitoring system 70 comprises a control device 75 and is designed to electrically contact the cells 57 of the energy storage device 55 in order to measure data relating to the cells 57 and. for example, to transmit them to the battery control unit 56 and/or other motor vehicle components.

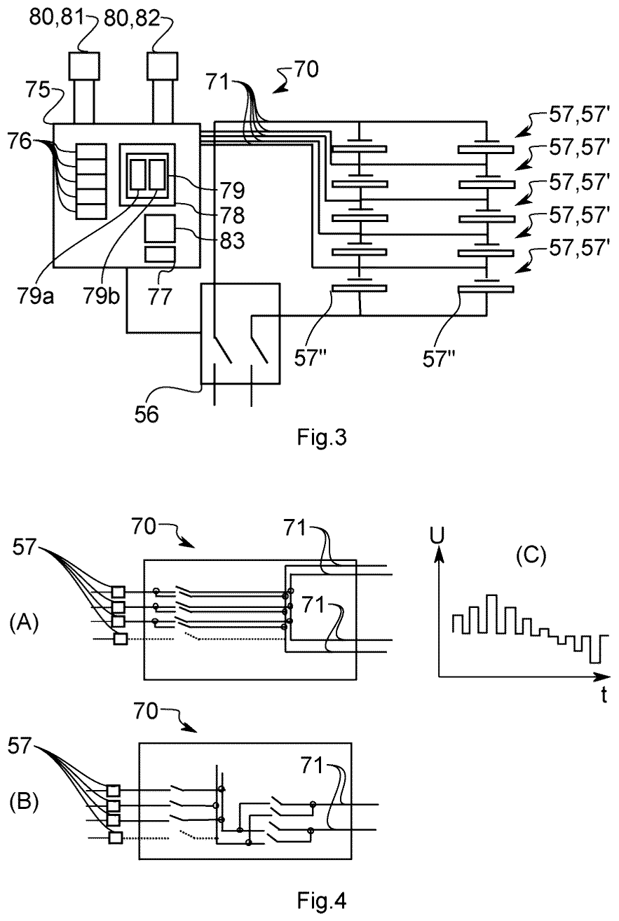

The cells 57 are physical cells 57″ (see FIG. 3) connected to logical cells 57′. The cells 57 are arranged in so-called battery modules (not shown). The cells 57 are designed to be able to carry out an electrochemical reaction in order to store or provide electrical energy. For example, the cells 57 comprise lithium ion cells and/or lithium iron phosphate cells.

The temperature control device 58 is designed to maintain the temperature of the cells 57, i.e., to control a temperature of the cells 57. In particular, a temperature of the cells 57 can be controlled in a closed-loop manner by the temperature control device 58 in order to bring the cells 57 into a thermally favorable operating point. For this purpose, the temperature control device 58 is designed to monitor the temperature of the cells 57 and to cool and/or heat the cells 57.

The motor vehicle 50 has a vehicle-side cooling system 53. The cooling system 53 is designed to cool components of the motor vehicle 55, for example an electric drive and/or power electronics (not shown in each case). The cooling system 53 is additionally designed to cool the energy storage device 55 and can for this purpose be operatively connected to the temperature control device 58.

When transporting electrical energy between the interfaces 80 and the energy storage device 55, the entire energy storage device 55 must be operated according to the prior art. Therefore, for example, the battery control unit 56 and the temperature control device 58, which are otherwise required for operating the electric drive, are operated. In addition, a bus system (not shown) is operated so that various components of the energy storage device 55 and/or of the motor vehicle 55 are connected in terms of communication technology, in order to be able to exchange information about the transport of the electrical energy, for example. This can entail a considerable consumption of electrical energy.

FIG. 2 schematically shows an electrically driveable motor vehicle 50 having an energy storage device 55, each according to one aspect of the disclosure. FIG. 2 will be described with reference to FIG. 1.

In the energy storage device 55 shown in FIG. 2, the interface 80 is directly electrically connected to the cell monitoring system 70 for supplying the interface 80 with electrical energy from the cells 57 and/or for supplying the cells 57 with electrical energy from the interface 80. A connection between the interface 80 and the high-voltage line 52 can thus be dispensed with. Thus, the cells 57′ can be electrically connected to the interface 80 via the cell monitoring system 70, as described with reference to FIGS. 3 and 4. In this case, for example, the battery control unit 56 and further secondary consumers can remain passive, as illustrated by boxes with dashed lines.

FIG. 3 schematically illustrates a cell monitoring system 70 and a plurality of cells 57 in accordance with an aspect of the disclosure. The cell monitoring system 70 according to FIG. 3 is a cell monitoring system 70 for an energy storage device 55 for an electrically driveable motor vehicle 50 having a vehicle-side electrical interface 80. FIG. 3 will be described with reference to FIG. 2.

The cell monitoring system 70 has a plurality of voltage taps 71 and a control device 75 for controlling the cell monitoring system 70. Each of the voltage taps 71 is designed to electrically contact one of the electrical cells 57 and the control device 75. The voltage taps 71 are measurement lines for monitoring the cells 57. The voltage taps 71 will also be used for transporting electrical energy between the cells 57 and the interface 80; the voltage taps 71 are thus used as power-conducting lines.

The control device 75 is electrically connected to the interfaces 80. Thus, the cell monitoring system 70 is designed to electrically connect the cells 57 to the interface 80, wherein the controller 75 is designed to selectively connect one or more of the plurality of voltage taps 71 to the electrical interface 80.

In this case, the cell monitoring system 70 has a voltage tap 71 per logic cell 57′. In the diagram of FIG. 3, two physical cells 57″ are connected in parallel to one another to form a logical cell 57′. In another embodiment (not shown), more than two physical cells 57″ may also be interconnected to form a logical cell 57′. Each of the cells 57 has a cell voltage that may be dependent on cell chemistry, state of charge, and aging. During operation, the cell voltage is, for example, in the range from about 4 V to 6 V.

By selectively connecting one or more of the voltage taps 71 to the electrical interface 80, all natural multiples of the cell voltage up to the voltage across all cells 57, i.e., the pack voltage, can be represented solely by a skillful interconnection. Selective connection means that any one or more voltage taps 71 can be connected. At a voltage tap 71, the cell voltage can be tapped. In the case of n voltage taps 71, the cell voltage can accordingly be tapped n times, wherein n is a natural number. Analogously, one cell 57 or n cells 57 can be supplied with electrical energy. By the selective connection, an arbitrary set of n voltage taps 71 can thus be connected, i.e., connected to the interface 80.

The control device 75 has a plurality of control modules 76. Each of the control modules 76 is designed to selectively connect the electrical interface 80 to a predetermined set of cells 57. In this case, the predetermined set of cells 57 is connected to the respective control module 76 via a corresponding predetermined set of voltage taps 71. In other words, each of the control modules 76 may electrically connect one or more of the predetermined set of voltage taps 71 to the interface 80. The predetermined amounts are selected in such a way that the control device 75 can respond to each of the voltage taps 71.

The control device 75 is designed to be supplied with electrical energy from the cell 57 and/or a plurality of cells 57. For this purpose, the control device 75 and/or each of the control modules 76 has a supply DC-DC converter. The supply DC-DC converter is designed to be supplied with a DC voltage by the and/or the cells 57 and to convert the DC voltage into a supply voltage for supplying the control device 75 with electrical energy.

The control device 75 is designed to control the connection of the electrical interface 80 to the one or more of the plurality of voltage taps 71 as a function of the load. The control device 75 is thus designed to change the switching of the voltage taps 71 for load balancing, for example in the event of a sharp drop in the cell voltage during the removal of electrical energy from the cells 57. Thus, the control device 75 is designed for load balancing. In this case, different cells 57 can be respectively supplied or loaded with different voltages, so that a quasi-active balancing of the cells 57 is ensured without energy having to be converted into heat in the process.

The control device 75 is designed to control the connection of the electrical interface 80 to the one or more of the plurality of voltage taps 71 in a time-dependent manner and thus to approximate an alternating current by switching the voltage taps 71 (see FIG. 4(C)) and/or to achieve load balancing. In other words, the control device 75 is designed to control the connection of the electrical interface 80 to the one or more of the plurality of voltage taps 71 such that an alternating current AC is modulated.

The cell monitoring system 70 has a cooling device 77 for passively cooling the control device 75. In this case, the control device 75 or each of the control modules 76 (not shown) has, for example, heat pipes and/or is conductively coupled to heat sinks, for example a cooling system 53 of the motor vehicle 50.

The control device 75 has an inverter 78 for supplying and/or loading the interface 80 with an alternating current AC; and a subset of the voltage taps 71 is connected to the inverter 78. The inverter 78 includes a resonant converter 79. The resonant converter 79 has a switchable capacitor 79a and a switchable inductor 79b. The switchable capacitor 79a and a switchable inductor 79b are independently switchable to adjust the resonance behavior of the resonant converter 79. The subset of the voltage taps 71 can have a smaller cross section than other voltage taps 71, because the higher the voltage of the DC voltage tap, the smaller the cable cross section can be selected with the same power. The inverter 78 is electrically connected to the alternating current interface 82 to provide electrical power to the alternating current interface 82.

The control device 75 has a DC-DC converter 83. The DC-DC converter 83 is electrically connected to the direct current interface 81 to enable transport of electrical energy between the direct current interface 81 and the cells 57. The DC-DC converter 83 provides galvanic isolation between the cells 57 and the direct current interface 81.

The control device 75 additionally has fuses (not shown), for example 8A/16A fuse for protecting the alternating current interface 82 and/or for protecting a DC measuring line.

FIG. 4 schematically shows two possibilities for selectively connecting one or more voltage taps 71 to an electrical interface 80 of an energy storage device 55 and a voltage profile of a cell monitoring system 70 according to one aspect of the disclosure. The cell monitoring systems 70 are each a variant of the cell monitoring system 70 described with reference to FIGS. 2 and 3.

FIG. 4(A) shows a configuration in which the cells 57 are connectable in series. By connecting n cells 57 in series, the cell voltage is obtained as an output voltage n times, wherein n is a natural number. A voltage profile is shown in FIG. 4(C), wherein the voltage U is shown as a function of the time t. At this time, the number n of the switched cells 57 changes successively to approximate an alternating voltage or an alternating current AC.

Arbitrary wave and/or step profiles can be represented by the switching. For this purpose, a specific interconnection combination, i.e., a switched set of voltage taps 71, is present for a specific time t and then changes to another set of voltage taps 71 with a potentially different number of voltage taps 71 in order to generate a different voltage. It is possible here that a sine is simulated by a switching sequence, as illustrated in FIG. 4(C). A 230 V (Europe) or 120 V (USA) voltage can be simulated. Optionally, a smoothing capacitor is installed on the output side in order to smooth the voltage profile shown.

FIG. 4(B) shows a variant of FIG. 4(A), wherein cells 57 can be connected in parallel with each other.

The variants shown in FIGS. 4(A) and 4(B) can be combined as desired.

### REFERENCE SIGNS

50 motor vehicle
51 vehicle-side connecting element
52 high-voltage line
53 vehicle-side cooling system
55 energy storage device
56 battery control unit
57 cell
57′ logical cell
57″ physical cell
58 temperature control device
70 cell monitoring system
71 voltage tap
72 cell contacting system
75 control device
76 control module
77 cooling device
78 inverter
79 resonant transducer
79a switchable capacitor
79b switchable inductor
80 interface
81 direct current interface
82 alternating current interface
83 DC-DC converter
91 photovoltaic device
92 power grid external to the vehicle
100 charging point
110 charging-point-side connector
AC alternating current
DC direct current

1-11. (canceled)

12. A cell monitoring system for an energy storage device for an electrically driveable motor vehicle having a vehicle-side electrical interface,
wherein the cell monitoring system is configured to be connectable to a plurality of voltage taps, and the voltage taps are each configured to electrically contact a cell of the energy storage device,
wherein the cell monitoring system comprises a control device configured to control the voltage taps, and
wherein the cell monitoring system is configured to electrically connect the cells to the vehicle-side electrical interface via the plurality of voltage taps.

13. The cell monitoring system according to claim 12,
wherein the control device is configured to selectively connect one or more of the plurality of voltage taps to the electrical interface.

14. The cell monitoring system according to claim 12,
wherein the control device is configured to be supplied with electrical energy from the cell and/or a plurality of cells.

15. The cell monitoring system according to claim 12,
wherein the control device comprises a plurality of control modules, and
wherein each of the control modules is configured to selectively connect the electrical interface to a predetermined set of cells.

16. The cell monitoring system according to claim 12,
wherein the cell monitoring system comprises a cooling device configured to passively cool the control device.

17. The cell monitoring system according to claim 12,
wherein the control device is configured to control the connection of the electrical interface to the one or more of the plurality of voltage taps as a function of load and/or as a function of time.

18. The cell monitoring system according to claim 12,
wherein the control device is configured to control the connection of the electrical interface to the one or more of the plurality of voltage taps such that an alternating current is modulated.

19. The cell monitoring system according to claim 12,
wherein the control device comprises an inverter configured to supply and/or load the interface with an alternating current, and
wherein a subset of the voltage taps is connected to the inverter.

20. The cell monitoring system according to claim 19,
wherein the inverter comprises a resonant converter configured to supply and/or charge the interface with the alternating current.

21. An energy storage device for an electrically driveable motor vehicle, comprising:
a plurality of cells; and
the cell monitoring system according to claim 12.

22. An electrically driveable motor vehicle, comprising:
the energy storage device according to claim 21.
